(19) United States
(12) Patent Application Publication
(10) Pub. No.: US 2026/0139737 A1
(43) Pub. Date: May 21, 2026

(54) Drive Device

(71) Applicant: Hydac Technology GmbH, Sulzbach / Saar (DE)

(72) Inventors: Peter Bruck, Althornbach (DE); Marcus Karl Pfeiffer, Ramstein-Miesenbach (DE)

(73) Assignee: Hydac Technology GmbH, Sulzbach / Saar (DE)

(21) Appl. No.: 19/120,130

(22) PCT Filed: Aug. 9, 2023
(86) PCT No.: PCT/EP2023/072041

§ 371 Date: Apr. 10, 2025

(30) Foreign Application Priority Data
Oct. 12, 2022 (DE) 10 2022 126 478.5

(51) Int. Cl. F16H 61/4078; F15B 15/18; F16H 61/4157; F16H 61/44

(52) U.S. Cl. CPC F16H 61/4078; F15B 15/18; F16H 61/44; F16H 61/4157

(57) ABSTRACT

The disclosure relates to a drive device with an electro-hydraulic drive and a hydraulic auxiliary system which generates an auxiliary torque which, if necessary, counteracts a main torque of the electro-hydraulic drive.

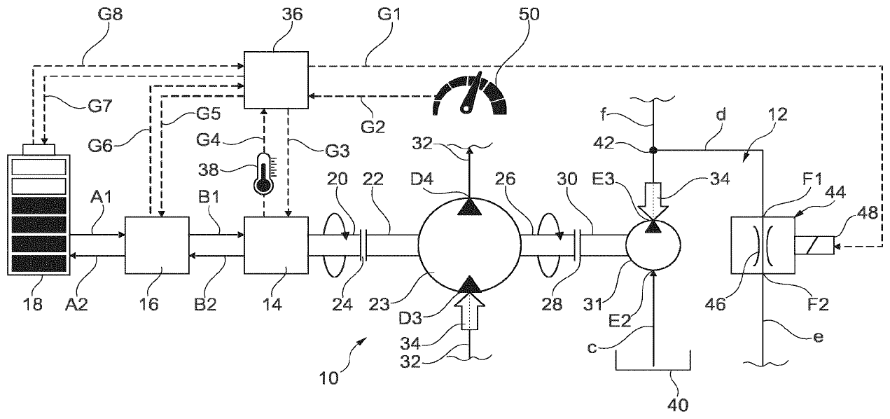

### CROSS-REFERENCE TO RELATED APPLICATIONS

This application claims priority to German Patent Application No. DE 10 2022 126 478.5, filed on Oct. 12, 2022 with the German Patent and Trademark Office. The contents of the foresaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a drive device, in particular for a mobile operating machine.

EP 3 569 775 B 1 discloses a hydraulic arrangement with a variable displacement pump, which can be driven by an internal combustion engine of a vehicle, a retarder valve being arranged on or in a working line of the hydraulic arrangement, by means of which valve the pressure medium conveyed by the variable displacement pump can be conducted to a retarder throttle, the hydraulic arrangement having a hydraulic braking function in retarder mode, the retarder throttle having a fixed cross-section, and a pump pressure or pump volumetric flow being able to be controlled or regulated in retarder mode. The pump volumetric flow and the fall in pressure at the fixed retarder throttle give rise to a power loss that can be controlled or regulated and thus to an additional braking torque that can be controlled or regulated for the hydraulic arrangement in retarder mode.

EP 2 399 861 B1 discloses a hydrostatic drive system of a mobile operating machine, in particular an industrial truck, having a working hydraulic system and a hydraulic pump for supplying the working hydraulic system, wherein the pump is driven by a drive machine, in particular an internal combustion engine, and takes the form of a variable displacement pump with an adjustable delivery volume. In this case, a pressure compensator is assigned to a feed line conducted from the pump to the working hydraulic system, said pressure compensator being configured as an inlet pressure compensator and being arranged in a return line that branches off the feed line to the container and is configured as a control valve that throttles in the intermediate position with a closed position and a throughflow position, the feed pressure of the pump arising in the feed line acting on said pressure compensator in the direction of the throughflow position, and a spring and the maximum load pressure of the controlled consumers of the working hydraulic system acting on said pressure compensator in the direction of the closed position, a heat exchanger apparatus for cooling the pressure medium of the drive system being arranged in the return line, the pressure medium volumetric flow flowing via the heat exchanger apparatus being able to be adjusted to the required cooling output of the drive system by changing the feed volume of the variable displacement pump. By using a variable displacement pump, it is possible to change and thus adjust the feed volume of the variable displacement pump regardless of the speed of the drive machine driving the pump. By correspondingly increasing or reducing the feed volume of the variable displacement pump in this process, a high flow of pressure medium can be made available in the return line to flow through the heat exchanger apparatus in the event of a high cooling output being required or reduced in the event of a low cooling output being required.

Furthermore, electric motor drives of the traditional design are known in the art in which the available torque is generated 100% via the installed electric motor for the drive or, during the braking process, as long as an independent service brake is not provided, is absorbed or, respectively, fed back into in an energy accumulator, for example in the form of a battery. In particular, the braking operation can lead to situations in which more energy is returned to the system than said system is able to receive in a specific operating state. The available excess energy can lead to damage or thermal overload of the available drive components if the energy absorption capacity of an accumulator, for example in the form of the battery, or the heat dissipation capacity of an inverter or motor should prove to be inadequate. Current drive systems that are freely available on the market can only deal with such eventualities to a limited extent. By means of what are known as braking choppers, it is indeed possible to limit the excess electrical energy fed back between the electric motor, inverter and accumulator medium, and thus protect the accumulator medium; however, it is not possible to reliably rule out a thermal overload of the electric motor in this process. In the event of such an overload, an electric motor then usually switches to what is known as a derating mode, in which only part of the torque can be used or absorbed. This means that a drive system can only be braked to an insufficient extent and is required to switch to emergency stop mode immediately for safety reasons.

### SUMMARY

A need exists to provide an improved drive device.

The need is addressed by the subject matter of the independent claim(s). Embodiments of the invention are described in the dependent claims, the following description, and the drawings.

### BRIEF DESCRIPTION OF THE DRAWING

The FIGURE shows, in outline and not to scale, a circuit diagram showing mechanical, hydraulic, and electrical components of the drive apparatus.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a drive device according to the teachings herein, equipped with an electrohydraulic drive and with a hydraulic auxiliary system, allows an auxiliary torque to be generated, which, if necessary, counteracts a main torque of the electrohydraulic drive. By means of the hydraulic auxiliary system, for example in the form of an overall hydromechanical assembly, a defined torque is deliberately applied to the electrohydraulic drive, said torque counteracting an undesirable torque applied from outside, formed by a hydraulic and/or mechanical load, as a result of which the mechanical and thermal load on the drive is reduced and overloading of components and derating of the electric motor can be avoided. This thus creates a drive that is always available and rules out undesirable interruptions in the working process, as can arise with current solutions.

For example, in this case, it may be provided that the auxiliary torque of the auxiliary system is achieved by a hydraulic resistor, which is for example controllable, by adjusting a hydraulic pressure. If a specific external torque of a hydraulic or mechanical nature is applied to the main drive in the form of the electrohydraulic drive when braking the operating function, this can be counteracted by adjusting the resistor of the device. Possible adjustment options are as follows: fixed, discrete digital, proportional, open or closed loop.

In some embodiments of the drive device, it is provided that, by means of the auxiliary torque, temperature regulation of the electric motor, for example incorporating an associated inverter and/or a battery supplying the electric motor, is achieved. This is achieved by adjusting the hydraulic pressure via a fixed or adjustable resistor, which can, if applicable, be controlled via an electronic control unit.

Temperature regulation for the electric motor and inverter can be achieved by means of
inverter and motor performance data as input variables (temperature, speed, current, torque, etc.) and/or
machine performance data as input variables (speed, direction, upwards/downwards, load, etc.) and/or
control signals, for example from a joystick, as input variables.

In some embodiments of the drive device, it is provided that the electrohydraulic drive comprises a hydraulic pressure supply apparatus, for example in the form of a fixed displacement hydraulic pump, which is coupled to a driven side of the electric motor via a drive train and to the drive side of the auxiliary system generating the auxiliary torque via a further drive train. In this manner, temperature regulation for the electric motor and inverter can be achieved by reducing the torque at a main drive shaft between the electric motor and the hydraulic drive of a mechanical-hydraulic component by means of discrete circuitry or proportional adjustment. Alternatively, a mechanical gearing component with transmission can also be used.

In some embodiments of the drive device, it is provided that the auxiliary system that generates the auxiliary torque comprises a further pressure supply apparatus, for example in the form of a further fixed displacement hydraulic pump, which can be driven via the further drive train of one pressure supply apparatus and generates a feed volumetric flow which is at least partially conducted via a hydraulic resistor. In this manner, a universally applicable apparatus to minimise the thermal load on an electrohydraulic drive and reliably protect an energy accumulator, for example in the form of a battery, by reducing the arising motor torque, can be achieved in a particularly cost-effective manner. This therefore has no parallel in the prior art.

Some embodiments of the drive device are covered in the further dependent claims and, furthermore, the use of a drive device as described above is also an aspect of the teachings herein.

Reference will now be made to the drawing in which the various elements of embodiments will be given numerical designations and in which further embodiments will be discussed. The drawing in outline and not to scale, represents a single figure in the form of a circuit diagram showing mechanical, hydraulic and electrical components of the drive apparatus.

Specific references to components, process steps, and other elements are not intended to be limiting. The FIGURE is schematic and not necessarily to scale.

The drive device shown in the FIGURE with its key components comprises an electrohydraulic drive 10, which interacts with a hydraulic auxiliary system 12. The auxiliary system 12 is able to generate an auxiliary torque, which, if necessary, counteracts a main torque of the electrohydraulic drive 10, which is explained in further detail below. Furthermore, the drive device comprises an electric motor 14 as part of the drive 10, which interacts with an inverter 16, which is in turn connected via paths A1, A2 to an energy accumulator in the form of a battery 18. Furthermore, the inverter 16 is coupled via appropriate paths B1, B2, to the electric motor 14. The electric motor 14 drives a drive shaft 22 in the usual manner via a driven shaft 20 for the purpose of driving a main drive 23 as part of the electrohydraulic drive 10. To this end, the driven shaft 20 is connected to the drive shaft 22 via a coupling point 24. Furthermore, the main drive 23 drives a further driven shaft 26, which is connected via a further coupling point 28 to a further drive shaft 30, which serves to drive the auxiliary system 12, or an associated auxiliary drive 31. As shown by the arrows on the drawing, all shafts 20, 22, 26, 30 rotate in the same direction.

The main drive 23 conducts fluid, such as hydraulic medium, for example, controlled by the drive output of the electric motor 14, in a closed or open hydraulic circuit 32, which is only reproduced partially in the FIGURE. The main transport direction of the main drive 23 is shown by the arrows depicted as D3 and D4 and the transport direction inside the circuit 32 is also indicated by an arrow. As such, the main drive 23 is configured in the form of a feed pump apparatus and, on its inlet side, is exposed to a load which is reproduced symbolically with an arrow 34 in the FIGURE. A corresponding load shown by an arrow 34 in the drawing is received for the output side of the auxiliary drive 31 as part of the hydraulic auxiliary system 12, which, in this manner, is exposed to this load on its output side E3.

Furthermore, the drive device in its entirely is a control device 36, which is also referred to in technical jargon as an ECU (Electronic Control Unit). The control device 36 is connected via control lines G5 and G6 to the inverter 16 and via further control lines G7 and G8 to the accumulator apparatus in the form of the battery 18. Furthermore, a temperature monitoring apparatus 38 is connected via a measurement data line G4, on the input side, to the control device 36, which in this manner transmits the current operating temperature of the electric motor 14, which is recorded by the temperature monitoring apparatus, to the control device 36. An additional control line G3, originating from the control device 36, serves to control the electric motor.

The auxiliary drive 31 in the form of a hydraulic pump is driven via the main drive 23 via shafts 26 and 30 and the coupling point 28 and is connected with its input side E2 to a feed line c, which takes fluid from a storage tank 40. The auxiliary drive 31 in the form of the feed pump then delivers fluid with a predefinable volume and predefinable pressure to a supply circuit f, which may be part of the overall hydraulic circuit 32. At a predefinable branch point 42 in the supply circuit f, for example immediately after the output side E3 of the auxiliary drive 31, a hydraulic resistor referred to in its entirely as 44 is connected into a bypass line d, fluid flowing through said resistor according to the representation in the FIG. from the side of the bypass line d between the ports F1 and F2 on the inlet side or on the outlet side of the resistor 44 respectively. A discharge line e is connected to the outlet side of the resistor 44 and thus to the port F12, fluid being able to be returned via said discharge line, for example to the storage tank 40 (not shown).

In the illustrated embodiment, the hydraulic resistor 44 is formed by an electrically proportionally actuatable adjustment throttle 46, an actuating magnet 48 serving to control the adjustment throttle 46, said magnet being able to be controlled by the control device (ECU) 36 via a control line G1. Instead of the adjustment throttle 46, a different resistor may be used, which is not shown, for example in the form of a nozzle, a fixed throttle, a mechanically adjustable throttle, a pressure limiting valve, an electrically digitally actuatable fixed throttle, an electrically digitally actuatable pressure limiting valve, an electrically proportionally actuatable pressure limiting valve, etc. In addition to using valves of any kind, it is also possible to create a hydraulic resistor 44 via a hydraulic accumulator apparatus, such as a hydraulic accumulator (not shown), for example.

Finally, it should be noted that so-called machine performance data such as speed, upwards/downwards direction, load, etc., is transmitted to the control device 36 via a suitable recording device 50.

With the drive device, a universally applicable apparatus for minimising the thermal load on the electromechanical drive in the form of the electric motor 14 is created and furthermore the accumulator, here in the form of the electric battery 18, is simultaneously protected, specifically in that the arising motor torque on the main drive 23 is reduced by means of the auxiliary drive 12 with its associated auxiliary drive 31 and the hydraulic resistor 44. In this manner, an apparatus for adjusting temperature management of an electromechanical drive 10 for the use in electrically driven mobile or quasi-mobile operating machines is provided. The aforementioned hydraulic auxiliary system 12 is, as already explained, coupled to the main drive 23 via a connection or coupling element 28. A certain reduction in pressure on the outlet side E3 of the auxiliary drive 31 inside a hydraulic circuit, here in the form of the supply circuit f, may be generated by means of the fixed or adjustable hydraulic resistor 44. This reduction in pressure in turn generates a certain auxiliary torque in the further drive shafts 30 via a mechanical-hydraulic component in the form of the auxiliary system 12, said drive shaft serving as what is known as an auxiliary drive shaft of the apparatus. The auxiliary torque required to support the main drive 23 is then transferred via the further coupling point 28 as a connecting element to the main drive shaft, i.e. to the further driven shaft 26. The further main drive shaft or the drive shaft 22 respectively is coupled mechanically to the driven motor shaft 20 via the connection point 24 in this process. If the resistance changes via the hydraulic resistor apparatus 44 on the outlet side E3 of the auxiliary drive 31, the auxiliary torque T on the further drive shaft 30 changes to support the electric motor 14. In this process, the torque T on the driven shaft 20 of the electric motor 14 is equal to the torque on the further driven shaft 26 less the torque on the further drive shaft 30. Accordingly, it also applies that the torque on the further driven shaft 26 is identical to the torque on the drive shaft 22 for the main drive 32.

If a specific external torque of a hydraulic or mechanical nature is then applied to the main drive 23 when braking the operating function, this can be counteracted by adjusting the hydraulic resistor 44 of the drive device, as has already been explained above. Accordingly, it is possible to provide temperature regulation for the electric motor 14 and the inverter 16 by adjusting the auxiliary torque on the further drive shaft 30 for the auxiliary drive 31 by adapting a hydraulic pressure on the outlet side E3 of the auxiliary drive 31 via the aforementioned fixed or adjustable resistor 44, which is for example controlled via the electronic control unit in the form of the control device 36. Furthermore, it is possible to provide temperature regulation for the electric motor 14 along with the associated inverter 16 by reducing the torque in the respective main drive shaft 22, 26 of a mechanical-hydraulic component in the form of the main drive 23 by discrete circuitry or proportional adjustment. Alternatively, a torque reduction could also be achieved by a mechanical gearing component by means of transmission.

In addition to the option of adaptive torque delay for the electric motor 14, it is also possible to use the drive device to perform charging capacity regulation for the accumulator, for example in the form of the battery 18, by means of so-called performance data for the accumulator medium such as charging state, temperature, load.

In summary, the drive device provides a form of retarder solution, which is particularly suitable for use with electrical machinery. In the event of a failure of any kind on the electrical drive side (electric motor 14 running too hot, inverter 16 collapsing, lines A1, A2, B1, B2 etc. overloaded, battery 18 full), in the case of machinery without a separate service brake, this can still be safely braked to a defined maximum speed or even brought to a standstill by using the aforementioned hydraulic auxiliary system 12.

In particular, machinery with hydrostatic traction drives in a closed circuit often does not have a separate service brake and braking takes place more or less by adjusting the feed pump, which then regulates the machinery. This is usually not a problem when using a diesel machine; however, it can be a problem with an electrical machine. In this case, the aforementioned problems may arise and cannot be resolved with the traditional hydraulic drive train set-up.

In a specific embodiment, the auxiliary drive 31 of the auxiliary system 12 on the mechanically connected drive train for the main drive 23 is used to establish a defined braking torque as required or in the event of a fault. To this end, the hydraulic resistor 44, for example in the form of a proportional pressure limiting valve, is used in the working port on the discharge side E3 of the auxiliary drive 31.

By applying a defined current on the electric motor side, the pressure and thus the braking torque follow the input signal. For example, an inverse pressure limiting valve is used as a hydraulic resistor 44 to ensure that a maximum braking power is guaranteed in the event of power failure.

The “state of health” of the main drive 23 is continuously monitored via a performance management system, which is for example implemented in the control device 36. If it is observed that the battery 18, electric motor 14, etc. need to be relieved to some extent, the retarder function (7-50 Nm) is applied in a correspondingly proportional manner and delayed in a braking manner.

Due to the modular structure of the drive device, it is also possible to retrofit said device in existing components on the respective operating machine.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A drive device with an electrohydraulic drive and with a hydraulic auxiliary system which generates an auxiliary torque which, if enabled, counteracts a main torque of the electrohydraulic drive.

12. The drive device of claim 11, wherein the auxiliary torque of the auxiliary system is provided by adjusting a hydraulic pressure via a hydraulic resistor.

13. The drive device of claim 11, wherein, using the auxiliary torque, temperature regulation of the electric motor is provided.

14. The drive device of claim 11, wherein the electrohydraulic drive comprises a hydraulic pressure supply apparatus, which is coupled to a driven side of the electric motor via a drive train and to the drive side of the auxiliary system generating the auxiliary torque via a further drive train.

15. The drive device of claim 11, wherein the auxiliary system that generates the auxiliary torque comprises a further pressure supply apparatus, which can be driven via the further drive train of one pressure supply apparatus and generates a feed volumetric flow which is at least partially conducted via the hydraulic resistor.

16. The drive device of claim 11, wherein the hydraulic resistor, on the fluid outlet side of the further pressure supply apparatus, generates a reduction in pressure which impacts the respective auxiliary torque via the further drive train of one pressure supply apparatus thereof.

17. The drive device of claim 11, wherein the hydraulic resistor can be adjusted by a control unit which can be controlled by a motor control unit (ECU), which receives sensor data from the electric motor via a sensor apparatus.

18. The drive device of claim 11, wherein the electric motor is supplied by at least one battery.

19. The drive device of claim 11, wherein the respective battery is connected to the motor control unit for charging capacity regulation.

20. A method of using the drive device of claim 11, wherein, using an overall hydromechanical system, a defined torque is applied to the drive as required, said torque counteracting an undesirable externally applied torque in a retarding manner.

21. The drive device of claim 11, wherein the auxiliary torque of the auxiliary system is provided by adjusting a hydraulic pressure via a controllable hydraulic resistor.

22. The drive device of claim 11, wherein, using the auxiliary torque, temperature regulation of the electric motor, incorporating an associated inverter and/or a battery supplying the electric motor, is provided.

23. The drive device of claim 12, wherein, using the auxiliary torque, temperature regulation of the electric motor, incorporating an associated inverter and/or a battery supplying the electric motor, is provided.

24. The drive device of claim 12, wherein, using the auxiliary torque, temperature regulation of the electric motor is provided.

25. The drive device of claim 12, wherein the electrohydraulic drive comprises a hydraulic pressure supply apparatus, which is coupled to a driven side of the electric motor via a drive train and to the drive side of the auxiliary system generating the auxiliary torque via a further drive train.

26. The drive device of claim 13, wherein the electrohydraulic drive comprises a hydraulic pressure supply apparatus, which is coupled to a driven side of the electric motor via a drive train and to the drive side of the auxiliary system generating the auxiliary torque via a further drive train.

27. The drive device of claim 14, wherein the hydraulic pressure supply apparatus is in the form of a fixed displacement hydraulic pump.

28. The drive device of claim 15, wherein the further pressure supply apparatus is in the form of a further fixed displacement hydraulic pump.

29. The drive device of claim 12, wherein the auxiliary system that generates the auxiliary torque comprises a further pressure supply apparatus, which can be driven via the further drive train of one pressure supply apparatus and generates a feed volumetric flow which is at least partially conducted via the hydraulic resistor.

30. The drive device of claim 13, wherein the auxiliary system that generates the auxiliary torque comprises a further pressure supply apparatus, which can be driven via the further drive train of one pressure supply apparatus and generates a feed volumetric flow which is at least partially conducted via the hydraulic resistor.
